(19) United States
(12) Patent Application Publication
(10) Pub. No.: US 2026/0083102 A1
(43) Pub. Date: Mar. 26, 2026

(54) ARTIFICIAL SEAWATER WITH ANTI-PATHOGEN PROPERTIES FOR FISH FARMS AND AQUARIUMS

(71) Applicant: Edward Noga, Marathon, IL (US)

(72) Inventor: Edward Noga, Marathon, IL (US)

(21) Appl. No.: 18/894,302

(22) Filed: Sep. 24, 2024

(51) Int. Cl. A01K 61/13

(52) U.S. Cl. CPC A01K 61/13

(57) ABSTRACT

A formula, APSW (Anti Pathogen Seawater), for preparing seawater for fish farms and aquariums that contains some or all the normal ingredients of sea salt with the exception of having low or no sulfates. Testing by the applicant has revealed that sea water without sulfates eliminates amyloodiniosis (Amyloodinium ocellatum), one of the most serious diseases of warm water marine fish. By reducing or eliminating sulfate from seawater, the invention may also prevent or provide treatment for other ectoparasites on aquatic animals, treat noxious dinoflagellates, treat bacterial diseases of marine animals, slow the growth or reduce the levels of microbes or parasites in shellfish, “starve” pathogenic bacteria, treat water-borne infectious diseases, prevent the formation of “off flavor” and prevent the formation of hydrogen sulfide.

This application repeats a substantial portion of prior Application No. 18,809,432], filed [Aug. 20, 2024], and adds disclosure not presented in the prior application. Because this application names the inventor or at least one joint inventor named in the prior application, it may constitute a continuation-in-part of the prior application.

### SPECIFICATION

### Field of the Invention

Patent class A01K63/04, arrangements for treating water specially adapted to receptacles for live fish

### Background

Aquariums have experienced a boom in popularity in recent years. Many saltwater aquariums include a diverse mix of tropical fish, live coral formations, and other exotic marine life. One of the most serious diseases of tropical marine fish, amyloodiniosis (caused by Amyloodinium ocellatum), the #1 or #2 problem in many salt water fish farm tanks and aquariums. Highly pathogenic (typically at or close to 100% mortality if not treated promptly), it can kill all fish within a few days if not treated properly.

Culture of warm water marine fish for food is also a rapidly expanding segment of aquaculture, with many species of fish cultured in the U.S. and worldwide. These fish are also severely impacted by amyloodiniosis, which can have a major impact on a farm's profitability.

This invention APSW, provides for the effective packaging, transport and retail sale of material containing salt and mineral compounds to generate a marine tank or other culture system for warm water marine fish that will eliminate any amyloodiniosis present on fish or in the fish culture system.

Affected fish may be at any salinity, since Amyloodinium can affect fish not only in full-strength seawater, but at very low salinity (almost freshwater).

There are two current most accepted remedies to treat amyloodiniosis:

### Copper Treatment

Copper at a dosage rate of 0.15-0.20 mg/L Cu²⁺ is used for control of fish parasites, including Amyloodinium and Cryptocaryon.

### Negative Points

Toxic (therapeutic dose very close to lethal dose for fish); also immunosuppressive.
Must treat for at least 14 days, some recommend up to 4 weeks.
Toxic to some marine fish.
Toxic to all invertebrates and algae.
Must inactivate some life support systems during treatment (e.g., activated carbon filtration).
Not environmentally friendly.
Two forms: ionic and chelated.
Ionic copper must be monitored closely (measure 1-2 times daily) with expensive test kit; must be removed with activated carbon after treatment.
Chelated copper does not need to be monitored, but cannot be removed with activated carbon
   must remove with water changes.
Copper (especially chelated copper) often remains bound to substrate (gravel, rock) in a tank and can be released (toxic) at a later date; thus, it is recommended to use copper in a hospital tank rather than in the display tank.
However, treating in a separate hospital tank is laborious, stressful for fish, often not feasible in large systems or when otherwise fish cannot be captured.

### Chloroquine Diphosphate Treatment.

Chloroquine diphosphate is typically dosed at a rate of 10 to 20 milligrams per liter (mg/l), with 15 mg/l being considered a standard dose for the treatment of amyloodiniosis.

### Negative Points

Also used as an antimalarial drug for people, which can make it difficult to acquire. If not available locally OTC, must obtain prescription from veterinarian, who may be reluctant to provide based upon issues with COVID.
Expensive,
Must treat for at least 14 days, possibly up to 4 weeks.
Cannot monitor dosage (no test kit available).
Must turn off many life support systems (skimmer, possibly biological filter).
Inactivated by light—must keep lights low and turn off UV sterilizer.
Can be microbially degraded—biological filters may inactivate.
Anorexia, too toxic for some fish.
Kills invertebrates and algae.

Anecdotal evidence that resistance may be developing to both medicines. There is documented resistance to chloroquine by malaria; other types of algae in polluted environments are resistant to copper

### Formula Elements

This invention lists a formula, the key element being the formulation is low in sulfate or sulfate-free. From the applicant's experience, when sulfate is removed from a marine fish tank, the amyloodiniosis parasite dies. Thus, the formula that is described herein is illustrative and not restrictive. Indeed, the formula may be carried out in a variety of compositions, with or without all the elements, and with varying amounts of the elements. The key to the invention is that there is little or no sulfate, and not that the other elements need to be a precise amount. Only that the primary element in the formula is sodium or compounds of sodium, with minor amount of other minerals.

A prior art application, PCT/EP050304, lists low or no sulfate seawater for breeding tanks for marine animals. But, the only claim of that application is the reduction or elimination of hydrogen sulfide. In addition, the formula does not include trace minerals, which this application lists. Even though the trace mineral content is only a small part of the formula, trace mineral elements are essential for biological, chemical, and physical processes in marine systems. These elements are involved in nutrient cycling, enzyme function, and the growth and development of marine organisms. Thus, as trace minerals may be essential to the successful application of the reduction or elimination of hydrogen sulfide, adding the trace mineral elements is novel to the prior art, and very important to the function of the formula. In addition, all of the other claims made in the current application are novel and for some but not necessarily all uses, trace minerals may be essential to the successful application of the enclosed claims.

APSW formula

| Salt components of formula | approximate percentage |
|---|---|
| Sodium chloride | 55% |
| Sodium | 33% |
| Chloride Salts of | |
| Calcium | <3% |
| Magnesium | <2% |
| Potassium | <2% |
| Trace and Assorted minerals | 5% |
| Copper | |
| Zinc | |
| Iron | |
| Phosphorus | |
| Iodine | |
| Zinc | |
| Selenium | |
| Chromium | |
| Strontium | |
| Manganese | |
| Lithium, | |
| Aluminum | |
| Rubidium | |
| Cobalt | |
| Carbonate | |
| Orthophosphate | |
| Molybdate | |
| Thiosulfate | |
| Bromide | |
| Iodide | Total 100% |

Other than reducing or entirely leaving out sulfates when producing artificial sea water, sulfates may also be removed from seawater by any means (nanofiltration, membrane filtration, anion exchange process in combination with K2SO4 precipitation, Etteringite precipitation and chemical removal, etc.) to reduce or eliminate sulfate from the water.

### Other Applications for the Formula

As a preliminary matter, it will readily be understood by one having ordinary skill in the relevant art of preparing marine salt water for aquariums and farm fish, that salt water without a normal level of sulfates of the present disclosure has broad utility and application over and above treating the amyloodiniosis parasite. Some of the other applications are:
1) Use to treat noxious dinoflagellates—The parasite Amyloodinium is a dinoflagellate. Most dinoflagellates are not parasitic but rather free-living photosynthetic algae. Some dinoflagellates can be a nuisance in aquarium systems because they form a slime that covers the surface of the aquarium. This is unsightly and can kill sedentary creatures (e.g., corals). Dinoflagellates often appear when a new aquarium is being established, but may also appear later. Using APSW rather than standard seawater would be expected to severely inhibit, if not totally prevent, the appearance of noxious dinoflagellates.
2) Treatment of other ectoparasites of marine fish, including Cryptocaryon irritans, scuticociliates, Brooklynella, Trichodina, monogeneans, turbellarians, copepods, and all other parasites that infest the surface of the skin and gills of fish, which covers to the best knowledge of the applicant, every parasite. Some ectoparasites may also penetrate into the surface of the skin or gills but they never extend beyond skin or gill tissue. The only exception is the scuticociliates, which can also cause systemic infections. Residing only on the skin or gills, ectoparasites may need sulfate to survive, since they have evolved to be at or near the surface of the fish and thus are in intimate contact with seawater at all times. Ectoparasites also will leave their host to either infest another fish, or in the case of Cryptocaryon, monogeneans, turbellarians, or copepods, leave the host to reproduce or otherwise continue their life cycle. Thus, especially when away from the host, they would not have another source of sulfur to access. Most free-living protists are phagotrophic (ingest particulate organic matter, such as bacteria, other protists, organic detritus, etc.), but parasitic ectoparasites while off the host would not have that capability since they derive nutrition from the host fish. This is demonstrated by them surviving without a host fish for only a very short time. However, while off the host (i.e., during reproduction or development), they may need to obtain some nutrients to survive, such as sulfur, to be incorporated into metabolic pathways. Thus, they might display osmotrophy (i.e., the uptake of dissolved nutrients such as sulfate) while off the host, since they are metabolically active (e.g., dividing or otherwise growing to form infective stages) while off the host and thus presumably would need to take up sulfate to incorporate into proteins.

Lack of sulfate may not always kill a certain parasite but still might reduce its pathogenicity enough to allow time for the host to mount an immune response, which occurs in response to fish ectoparasites.
3) Treating bacterial diseases of marine fish—This could include any marine fish (not just warm water fish). Most pathogenic marine bacteria must be present in seawater to be transmitted from one fish host to another. Some reside mainly on the surface of the fish, where they damage the skin and gills. Sulfate is needed for survival of marine bacteria, since they use sulfate as their primary source of sulfur. Bacteria can also obtain pre-reduced sulfur from the seawater dissolved organic sulfur (DOS) pool, into which labile organic sulfur compounds are released from phytoplankton and other marine microorganisms. However, in the artificial environment of an aquaculture system, changing the water to nutrient-lacking APSW would eliminate sulfate, as well as greatly reduce the availability of DOS, thus “starving” the pathogenic bacteria. Therefore, absence of or low sulfate may kill these bacteria, or otherwise reduce their pathogenicity by weakening them.
4) Using APSW with healthy-looking fish to eliminate the infection before it becomes a disease. Amyloodinium is probably carried asymptomatically on healthy fish since it cannot survive in the environment (obligate parasite). So, the APSW could be used to remove all parasites from even a healthy-looking fish population to prevent any future outbreaks. Other pathogens are also carried asymptomatically and thus may also be eliminated from healthy-looking marine animals.
5) Using APSW to slow the growth or reduce the levels of microbes or parasites in seafood, including but not limited to oysters, clams, shrimp and fish. Seafood may be treated while alive (e.g., during depuration of oysters, after placing in live holding tanks on a ship, or placing on ice on a ship), after being processed to various degrees (e.g., shucked oysters, fish fillets, etc.), during shipment, or during storage prior to sale.

Microbial contamination is one of the most serious problems in the seafood industry. Viruses, bacteria and parasites pathogenic to humans originating from seafood can cause serious illness and even death. Thus, reducing the prevalence of microbes or parasites pathogenic to humans, such as Vibrio vulnificus and Vibrio parahemolyticus, is a major concern to all processed seafood, including fish and shellfish (e.g., oysters, clams, etc.). Spoilage bacteria can render a seafood product inedible. Preventing the growth of spoilage bacteria, such as Pseudomonas, Aeromonas and Acinetobacter, is also a top priority. Certain fungi (yeast) can also be spoilage microbes.

The most common method for reducing the impact of human-pathogenic or spoilage microbes is low temperature, which slows the growth rate of the microbes. However, this has serious limitations, especially if the seafood product is already contaminated with undesirable microbes at certain levels. Thus, many methods have been developed and/or are under development to prevent or reduce the occurrence of pathogenic and spoilage microbes in seafood. These include irradiation, modified atmosphere packaging, hydrostatic pressure processing (HPP), mild heat processing, individual quick freezing (IQF) with extended frozen storage, dielectric barrier discharges, hyperbaric storage, ozonation, pulsed electric field, phage treatment, cold plasma and sous vide.

A limitation to these methods is high cost of equipment, materials and/or labor. Treatments must also usually be done on site (i.e., at the seafood processing plant), where the equipment and manpower are located. Another limitation is that for most methods, once the treatment is done, the microbes can once again resume growing.

As with fish-pathogenic bacteria, APSW may also inhibit the growth or survival of microbes that contaminate seafood. In one application, APSW could be used as the seawater for depuration of seafood to purge them of microbial contaminants. Depuration is the placement of live seafood (typically oysters or other bivalves) in clean seawater after harvest, to allow them to purge themselves of certain microbial contaminants originating from polluted waters, such as Escherichia coli, a human enteric bacterium. However, depuration with natural seawater does not always as effectively reduce the presence of marine bacterial pathogens or spoilage bacteria.

APSW could also be used to treat seafood immediately after capture during transport to the processing facility. Placing live seafood in holding tanks containing APSW or on ice made from APSW could inhibit growth of deleterious microbes, including psychrophilic (cold-adapted) microbes.

Once at the processing plant, seafood could be rinsed with APSW to displace natural seawater from the surface of the seafood, acting as an antimicrobial coating. Seafood could also be treated with APSW for various periods of time to reduce or eliminate deleterious microbes, as is done with certain other methodologies (e.g., treatment with D-tryptophan). Seafood could also be packed for shipment in APSW. Thus, APSW could act as a preservative, preventing or reducing the growth of deleterious microbes.

### Marine Applications for APSW

Reduce the availability of sulfates, thus “starving” pathogenic bacteria. Therefore, absence of, or reduced, sulfate may kill these bacteria, or otherwise reduce their pathogenicity by weakening them. Similarly, marine culture systems may also experience bacterial “blooms”, which are unsightly (cloud the water) and may be harmful to marine animals; these bacteria would also be expected to be negatively affected by low or no sulfate.

Treat water-borne infectious diseases of other marine animals, including but not limited to crustaceans, mollusks, corals. Such pathogens would include ectoparasites such as Zoothamnion and Vorticella on shrimp and crabs, as well as bacterial pathogens.

Use as a combination treatment with another drug or method—APSW or otherwise seawater with reduced or no sulfate might facilitate or synergize with other methods used to treat marine animal diseases. For example, if the lack of sulfate weakens a pathogen, it might require less of the companion drug to treat that pathogen.

Prevent the formation of “off flavor”—Lowering or eliminating sulfate may also inhibit microbes that produce chemicals responsible for “off flavor” in recirculating aquaculture system (RAS)-cultured marine animals. Off flavor is a taint that is imparted to the flesh due to the production of certain compounds (geosmin, 2-methylisoborneol) by bacteria in an RAS. These compounds give the flesh a distasteful flavor, making it unsalable. Thus, farmers must spend considerable time and money placing their animals in clean water for an extended time to allow these chemicals to dissipate from the flesh. Reducing the prevalence of these microbes in the RAS would be a significant financial benefit to farmers.

Preventing the formation of hydrogen sulfide—In the marine environment, sulfate is reduced to hydrogen sulfide (H₂S) by microbes (Desulfovibrio); H₂S is highly toxic to marine life, interfering with re-oxidation of cytochrome a₃ in respiration. Hydrogen sulfide is toxic to biofilter microbes and fish are stressed by sublethal H₂S, making them more susceptible to disease. Hydrogen sulfide is a serious problem in salmonid RAS and has recently been suspected of causing a number of mass mortalities in RAS. Thus, reducing or eliminating sulfate may actually produce a superior, “healthier” seawater compared to the standard natural seawater formulation. This application may extend beyond finfish aquaculture since shrimp and other invertebrates are being raised with increasing frequency in RAS with artificial seawater, and hydrogen sulfide can also be a problem in those systems.

### Advantages of APSW in Treating Amyloodiniosis:

Strong experimental evidence that it kills 100% of Amyloodinium parasites in vitro
In vitro model is highly similar to the host-parasite interaction in vivo
This treatment targets the parasitic stage on the fish (trophont), unlike all other medicines that typically target the parasitic stage that is off the fish (dinospore)
If the trophont is not affected by a treatment, morbidity and mortality continues while the parasites continue to feed and grow on the fish, and until the parasites leave the host to form the dinospore
In vitro evidence suggests that APSW may completely cure fish of amyloodiniosis; if so, no possibility that disease can recur after treatment. This is less likely to occur with copper or chloroquine because they target the dinospore Amyloodinium is an obligate parasite and so must be present in a latent/carrier state on the fish when not causing a disease outbreak. It cannot survive in the environment.
APSW may be “reef-safe”, i.e., usable in an aquarium that has not only fish, but invertebrates (corals, shrimp, crabs, etc.). There is no treatment that can safely (for invertebrates) treat fish for amyloodiniois in a reef tank.
APSW could be used not only as a treatment but also as a substitute for commercial artificial seawater in growing or maintaining aquarium fish or food fish.

I claim:

1. An artificial seawater with anti-pathogen properties for use in fish farms and aquariums that will kill or inhibit Amyloodinium, a parasite, by depriving the parasite of levels of sulfate ion that are required for survival or growth, the artificial seawater being comprised of these essential components:
Sodium chloride
Chloride salts of
Calcium
Magnesium
Potassium
Trace minerals
Copper
Iron
Chromium
Manganese
Lithium
Rubidium.

2. The artificial seawater of claim 1 to act in combination with drugs for killing or inhibiting the Amyloodinium parasite.

3. (canceled)

4. (canceled)

5. The artificial seawater of claim 1 for killing or inhibiting other ectoparasites of marine fish, the ectoparasites comprising Cryptocaryon irritans, scuticociliates, Brooklynella, Trichodina, monogeneans, turbellarians, and copepods, parasites that infest the surface of the skin and gills of fish.

6. The artificial seawater of claim 1 to act in combination with drugs for killing or inhibiting other ectoparasites of marine fish, the ectoparasites comprising Cryptocaryon irritans, scuticociliates, Brooklynella, Trichodina, monogeneans, turbellarians and copepods.

7. The artificial seawater of claim 1 for killing or inhibiting bacterial pathogens of marine fish.

8. The artificial seawater of claim 1 to act in combination with drugs for killing or inhibiting bacterial pathogens of marine fish.

9. (canceled)

10. (canceled)

11. The artificial seawater of claim 1 for killing or inhibiting water-borne pathogens of marine invertebrates.

12. The artificial seawater of claim 1 to be used in combination with drugs for treating water-borne pathogens marine invertebrates.

13. The artificial seawater of claim 1 to inhibit microbes that produce chemicals responsible for “off flavor” in cultured marine animals, “off flavor” being caused by accumulation of geosmin and 2-methylisoborneol.

14. The formula of claim 1 to act in concert with depuration, algicides, adsorbents, biological control, or disinfection for inhibiting microbes that produce chemicals responsible for “off flavor” in cultured marine animals, “off flavor” being caused by accumulation of geosmin and 2-methylisoborneol.

15. The artificial seawater of claim 1 for eliminating pathogens from healthy-looking marine animals.

16. The formula of claim 1 to act in concert with drugs in eliminating an infection from healthy-looking marine animals before it becomes a disease.

17. The artificial seawater of claim 1 where sulfate-free or reduced sulfate water is created by removing sulfate from regular seawater by means of nanofiltration membrane filtration, anion exchange process in combination with K2SO4 precipitation, Ettringite precipitation or chemical removal to kill or inhibit pathogens, treat diseases, or control off-flavor.

18. The artificial seawater of claim 1 for preventing the formation of hydrogen sulfide.

19. The artificial seawater of claim 1 produced by removing sulfate from seawater by means of membrane filtration, anion exchange process in combination with K2SO4 precipitation, Ettringite precipitation or chemical removal, to reduce or eliminate sulfate from regular seawater to prevent the formation of hydrogen sulfide.

20. The artificial seawater of claim 1 to slow the growth or reduce the levels of microbes or parasites in seafood, comprising oysters, clams, shrimp and fish; the artificial seawater may be used with seafood that may be treated while it is alive, during depuration of oysters, after placing in live holding tanks on a ship, or placing on ice on a ship after being processed to various degrees comprising shucked oysters, and fish fillets or during shipment, or during storage prior to sale.

21. The artificial seawater of claim 1 to act in combination with other methods for treating microbial contamination of marine seafood comprising low temperature, irradiation, modified atmosphere packaging, hydrostatic pressure processing (HPP), mild heat processing, individual quick freezing (IQF) with extended frozen storage, dielectric barrier discharges, hyperbaric storage, ozonation, pulsed electric field, phage treatment, cold plasma and sous vide.
